(19) United States
(12) Patent Application Publication
(10) Pub. No.: US 2005/0132679 A1
(43) Pub. Date: Jun. 23, 2005

(54) Dust collection system and related airlock

(76) Inventor: Neil R. Tyburk, Canton, OH (US)

Correspondence Address: SAND & SEBOLT, AEGIS TOWER, SUITE 1100, 4940 MUNSON STREET, NW, CANTON, OH, 44718-3615, US

(21) Appl. No.: 10/740,719

(22) Filed: Dec. 18, 2003

(51) Int. Cl. B01D 46/00

(52) U.S. Cl. 55/425

(57) ABSTRACT

An airlock for a dust collection system includes a housing defining an interior chamber, an entrance hole and an exit hole, each hole being in fluid communication with the interior chamber. A rotor body rotates within the interior chamber and defines at least one airlock chamber so that there is never fluid communication between the entrance hole and the exit hole, thus allowing particulate material to enter and exit the airlock without the need for a collection bin being sealed to the dust collection system.

### BACKGROUND OF THE INVENTION

1. Technical Field

The present invention relates generally to a dust collection system. More particularly, the invention relates to a dust collection system which separates lighter materials that are captured by a filter and heavy materials that fall into a collection bin. Specifically, the invention relates to a dust collection system including an airlock which allows the system to be used without a collection bin being sealed to the system.

2. Background Information

It is customary in the field of woodworking and other arts to provide a dust collection system connected to a series of machines wherein dust and various size particles of wood or other materials are removed from the machines. Such systems commonly have a separator which allows heavy material to fall into a collection bin while light material is captured by a filter. These dust collection systems are essentially a vacuum system allowing for the separation of the light and heavy materials.

One problem area that arises with the dust collection system relates to the need to empty the dust collection bin. Aside from the intake and exhaust openings, the dust collection systems are generally sealed throughout to ensure that dust and heavier particulate matter is not discharged in undesired places. Thus, the dust collection bin is sealed to the remainder of the system. Additionally, the dust collection bin has traditionally been sealed to the system in order to assure that a negative pressure is consistently realized within the system. Several problems arise related to the need to provide a seal between a collection bin and the rest of the system. One of the problems is that in order to empty the dust collection bin without discharging both light and heavy materials out of the system in an uncontrolled fashion, the system must be turned off. Another problem is that the connections making the seal with the collection bin are typically cumbersome, thus making removal of the bin difficult and time consuming. A further problem relates to the size of collection bins. Commonly, a collection bin may be a 55-gallon or similar size drum, which makes the bin unwieldy and difficult to empty especially when full. Resolution of these problems is a primary concern herein.

Thus, the art desires a dust collection system wherein the system need not be turned off in order to empty a dust collection bin. Further, it is desirable to create a system having a dust collection bin separated from the system to eliminate the need for a cumbersome seal. Further, it is desirable that small, and thus relatively light-weight, collection bins can be used to facilitate their movement for emptying. A dust collection system that eliminates the need for a collection bin altogether is likewise desirable. For instance, the dust collection system could drop the heavy material onto a pallet or a conveyor system if desired.

### BRIEF SUMMARY OF THE INVENTION

The present invention provides an airlock having a housing defining an interior chamber, an entrance hole and an exit hole, each hole being in fluid communication with the interior chamber; a rotor body disposed within the interior chamber and being rotatable about a longitudinal axis; and the rotor body defining at least one airlock chamber so that at no time is there fluid communication between the entrance hole and the exit hole.

The present invention further provides a dust collection system having a blower in fluid communication with a source of particulate material and with a separator; the particulate material comprising light material and heavy material separatable by the separator; the separator in fluid communication with a filter for capturing the lighter material; and an airlock for receiving and discharging the heavy material; the airlock comprising a housing defining an interior chamber, an entrance hole and an exit hole, each hole being in fluid communication with the interior chamber; a rotor body disposed within the interior chamber and being rotatable about a longitudinal axis; and the rotor body defining at least one airlock chamber so that at no time is there fluid communication between the entrance hole and the exit hole.

The present invention also provides a method of collecting particulate material comprising the steps of providing a particulate material collection system having a blower in communication with sources of particulate material comprising light material and heavy material; the blower being in communication with a separator; the separator being in communication with a filter for capturing the light material; an airlock being in fluid communication with the separator; the airlock comprising a housing defining an interior chamber, an entrance hole and an exit hole, each hole being in fluid communication with the interior chamber; a rotor body disposed within the interior chamber and being rotatable about a longitudinal axis; and the rotor body defining at least one airlock chamber so that at no time is there fluid communication between the entrance hole and the exit hole; operating the blower to move the particulate material through the system; collecting a portion of the heavy material in the at least one airlock chamber; and rotating the rotor body to discharge the portion of the heavy material from the at least one airlock chamber.

### BRIEF DESCRIPTION OF THE SEVERAL VIEWS OF THE DRAWINGS

FIG. 1 is a schematic view of a first embodiment of the airlock of the present invention connected to a typical dust collection system.

FIG. 2 is a perspective view of the first embodiment of the present invention.

FIG. 3 is an exploded perspective view of the first embodiment of the invention.

FIG. 4 is a sectional view of the first embodiment of the invention as seen from the side.

FIG. 5 is a sectional view taken along line 5-5 of FIG. 4.

FIG. 6 is a fragmentary sectional view of the dust collection system shown in FIG. 1 showing an initial accumulation of heavy material falling into an airlock chamber between a pair of adjacent blades, with a rotated position of the blades being shown in phantom.

FIG. 7 is similar to FIG. 6 but shows the blades of the airlock rotated 90degrees from the position shown in FIG. 6, with the initial accumulation having moved downwardly and laterally to an intermediate position, and subsequent heavy material in another airlock chamber between a second pair of adjacent blades.

FIG. 8 is similar to FIG. 7 except that the blades of the airlock are rotated an additional 90 degrees to show the initial accumulation being discharged downwardly out of the airlock and subsequent heavy material in another airlock chamber between a third pair of adjacent blades.

FIG. 9 is an exploded perspective view of a second embodiment of the present invention.

FIG. 10 is a sectional view of the second embodiment of the present invention as seen from the side.

FIG. 11 is a partially exploded perspective view of a third embodiment of the present invention.

FIG. 12 is a perspective view of the third embodiment of the present invention.

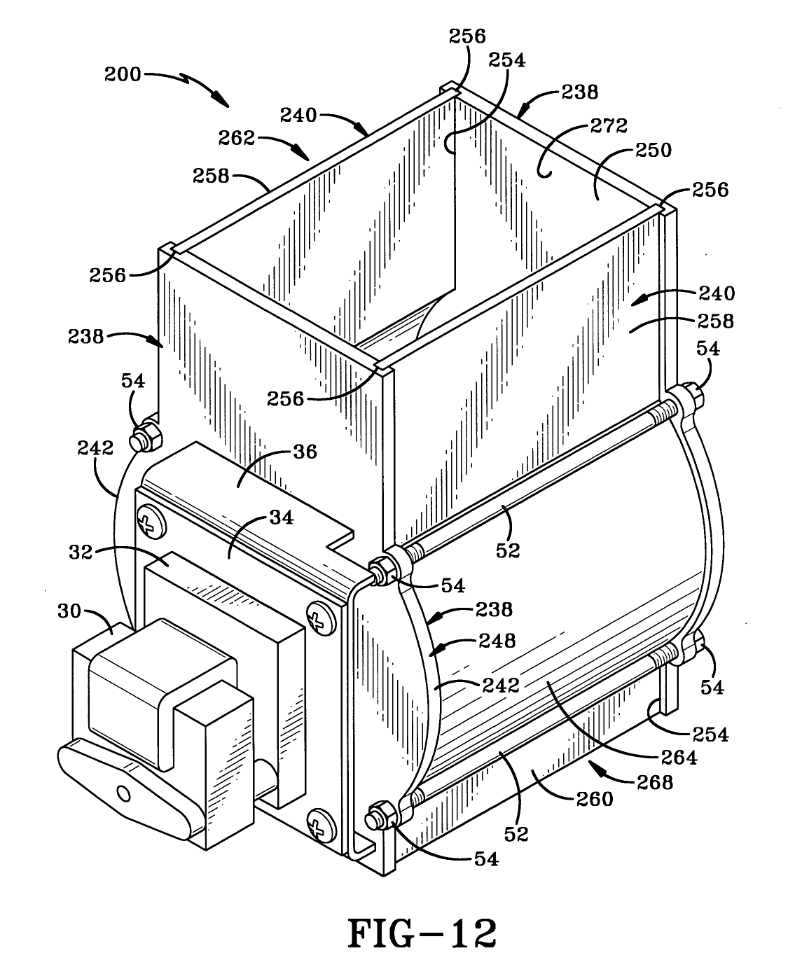

### DETAILED DESCRIPTION OF THE INVENTION

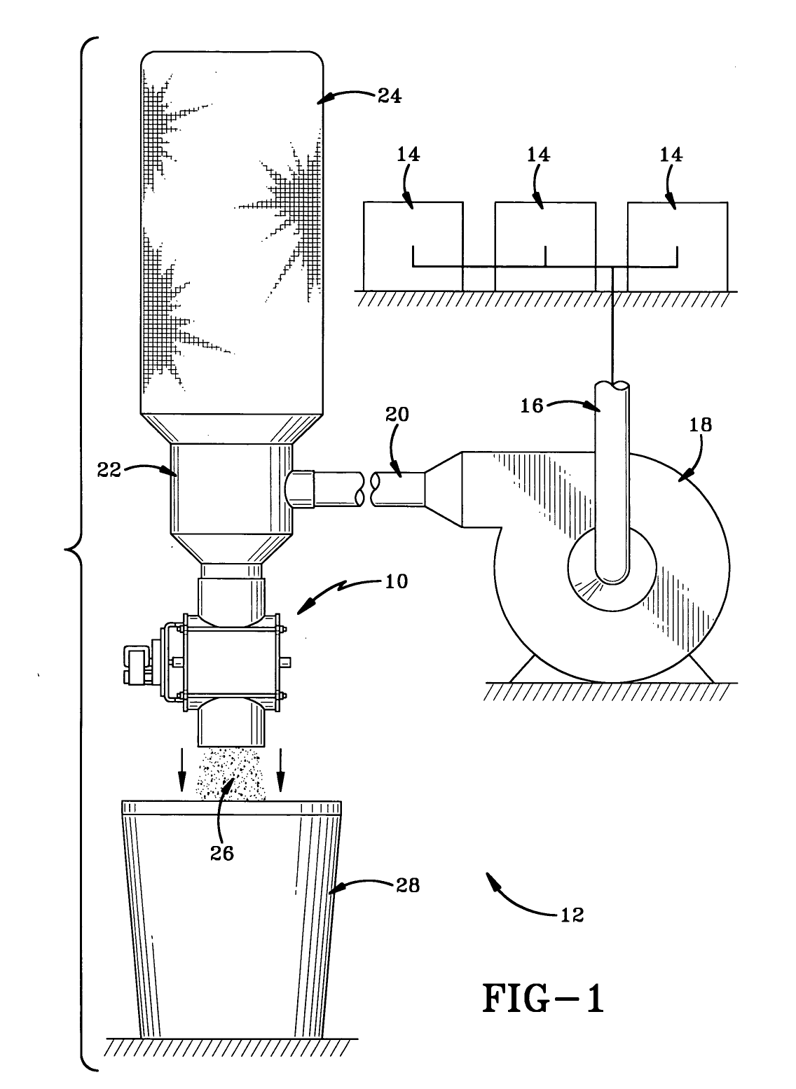

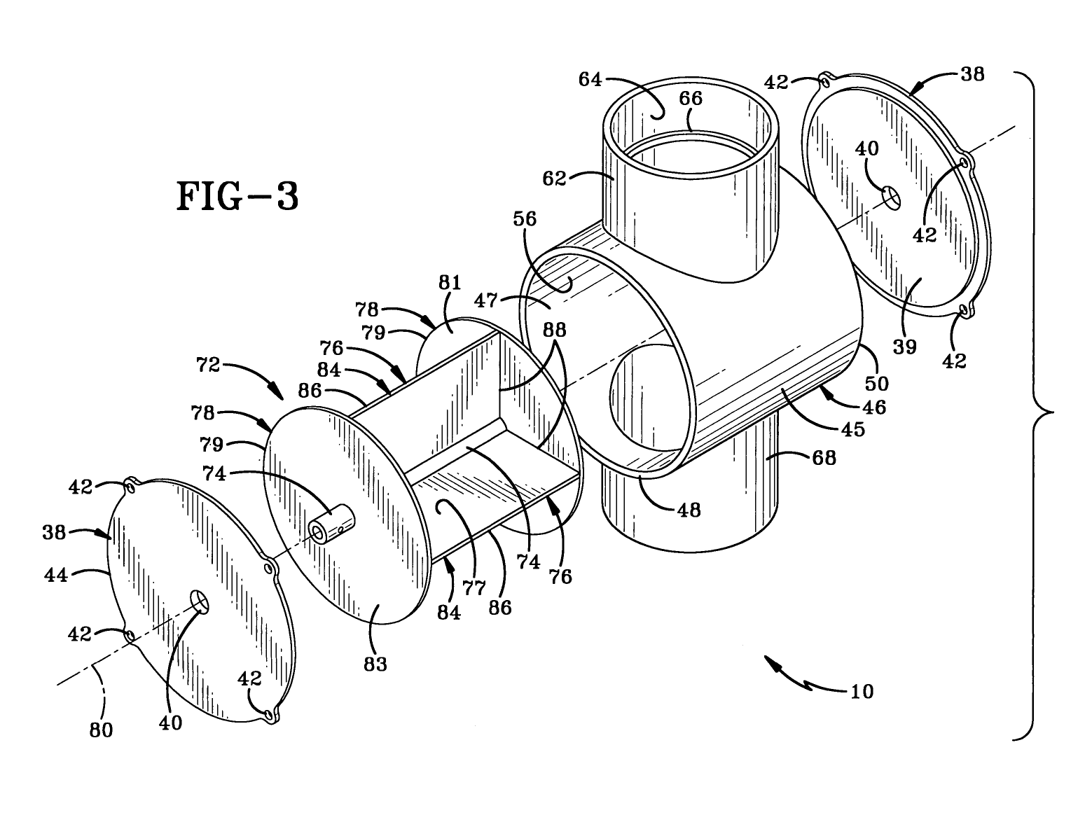

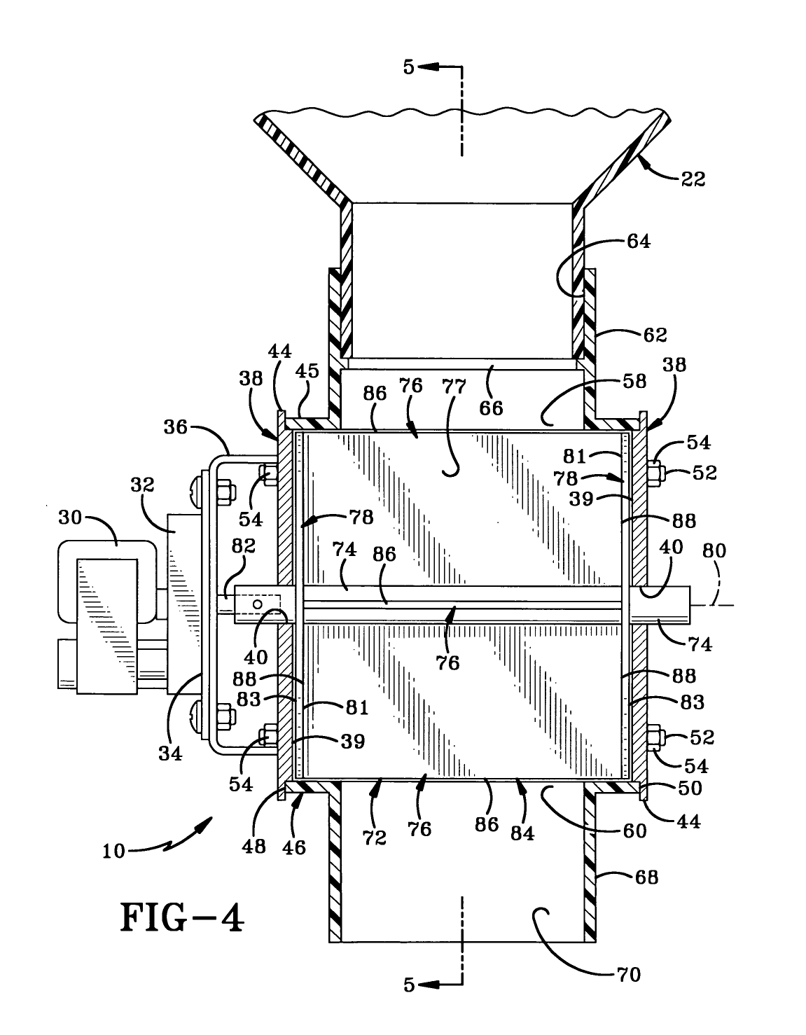

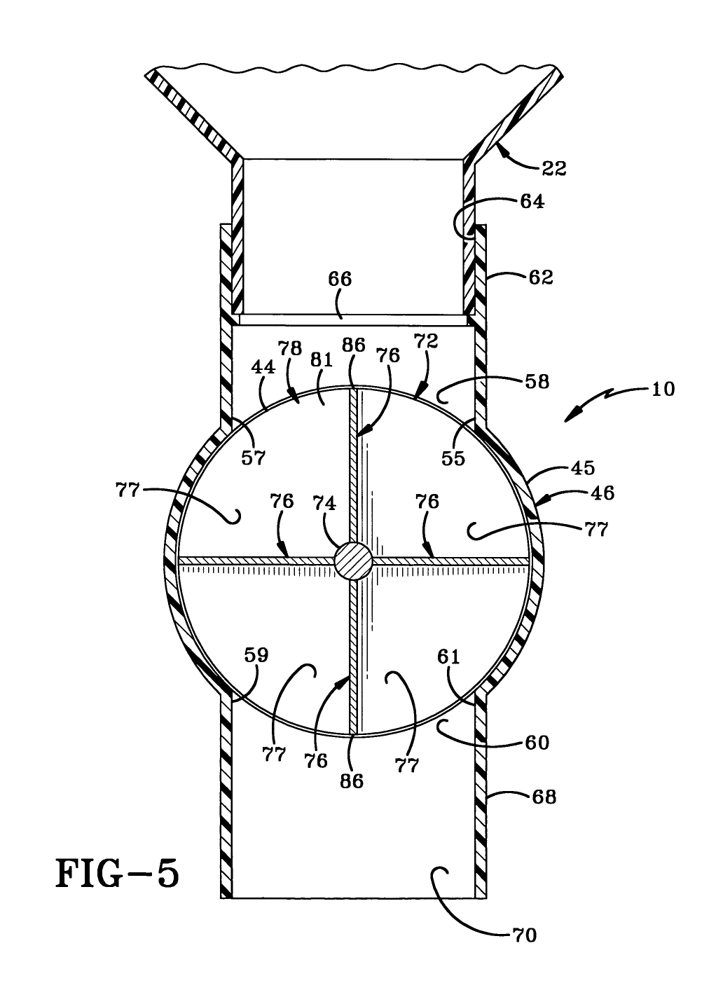

An airlock of the present invention, used with a dust collection system, is indicated generally at 10 and is shown particularly in FIGS. 1-8. Airlock 10 is used as a component of dust collection system 12, as seen in FIG. 1, which removes dust and other particulate material from machines 14. Dust collection system 12 includes pipes 16 in fluid communication with machines 14 and blower 18. Another pipe 20 is in fluid communication with blower 18 and separator 22. Separator 22 in turn is in fluid communication with filter 24 extending upwardly therefrom and with airlock 10 there below. Dust collection system 12 further includes a heavy material 26 collection site, which may be a collection bin 28.

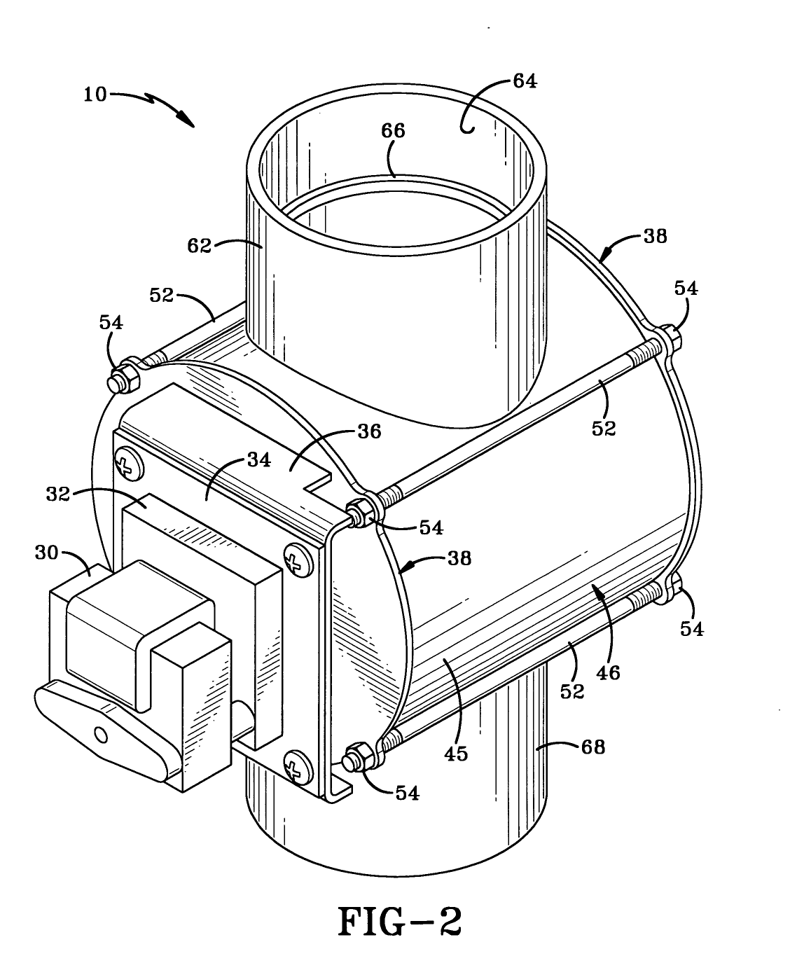

Referring to FIG. 2, airlock 10 includes an electric motor 30 as its power source and a gear box 32 which is connected to motor 30. In turn, gear box 32 is connected to mounting member 34, which is mounted on mounting plate 36. Mounting plate 36 is connected to one of a pair of caps 38, each defining a central hole 40 and a plurality of mounting holes 42 adjacent an outer perimeter 44 of cap 38.

Airlock 10 further includes a blade housing which comprises the pair of opposed end walls or caps 38 and a hollow cylinder 46 having a sidewall 45, a first end 48 and a second end 50. Caps 38 are connected to cylinder 46 at first end 48 and second end 50 respectively by threaded rods 52 and nuts 54. The blade housing defines an interior chamber 56. The blade housing has an inner surface which comprises an inner surface 47 of cylinder 46 and inner surface 39 of each cap 38. Cylinder 46 defines an entrance hole 58 and an exit hole 60 in opposed relation to entrance hole 58. Referring to FIGS. 24, Entrance hole 58 includes a leading edged 55 and a trailing edge 57, and exit hole 60 includes a leading edge 59 and a trailing edge 61. A cylindrical entry duct 62 extends upwardly from cylinder 46 and defines an entrance opening 64 in fluid communication with entrance hole 58. Entry duct 62 further includes a stop in the form of an inwardly extending annular flange 66. The lower end of separator 22 is inserted into entry duct 62 of airlock 10 to form an air tight seal between the lower portion of separator 22 and entry duct 62. The insertion of lower portion of separator 22 into entry duct 62 of airlock 10 is limited by annular flange 66. An exit duct 68 extends downwardly from cylinder 46 and defines an exit opening 70 in fluid communication with exit hole 60.

Airlock 10 further includes a rotor body, which is preferably a blade assembly 72 comprising a blade shaft 74, a plurality of rectangular blades 76 and a pair of opposed circular end plates 78. Blade assembly 72 defines an airlock chamber 77 between each adjacent pair of blades 76 and between wedge-shaped portions of respective end plates 78. Blade shaft 74 has a longitudinal axis 80 and is connected to a drive shaft 82 extending outwardly from gear box 32. Drive shaft 82 is coaxial with longitudinal axis 80 of the blade shaft 74. Blades 76 extend radially outwardly from blade shaft 74, each blade 76 having an outer perimeter 84 comprising an outer edge 86 and a pair of opposed parallel ends 88, each of which are perpendicular to outer edge 86.

Blade assembly 72 is disposed within interior chamber 56 with blade shaft 74 extending through each of central holes 40 of respective caps 38. Outer surfaces 83 of respective end plates 78 lie adjacent the respective inner surfaces 39 of caps 38, thereby limiting the lateral movement of blade assembly 72 along longitudinal axis 80. Each outer perimeter 79 of end plates 78 is continuously adjacent inner surface 47 of cylinder 46. The outer edge 86 of each blade 76 is also continuously adjacent inner surface 47 when outer edge 86 of blade 76 is not in communication with either entrance hole 58 or exit hole 60 of cylinder 46. Said another way, outer edge 86 of a given blade 76 is continuously adjacent inner surface 47 when the given blade 76 is disposed between leading edge 55 of entrance hole 58 and trailing edge 61 of exit hole 60 or when the given blade 76 is disposed between trailing edge 57 of entrance hole 58 and leading edge 59 of exit hole 60. (It is noted, however, that certain alternately-shaped blades may curve so that the outer edge of the blade may be continuously adjacent inner surface 47 while certain portions of those blades are not disposed between leading edge 55 of entrance hole 58 and trailing edge 61 of exit hole 60 or between trailing edge 57 of entrance hole 58 and leading edge 59 of exit hole 60.) End plates 78 are connected to either blade 76 or blade shaft 74 or both such that inner surface 81 of each end plate 78 lies continuously adjacent a respective end 88 of blade 76 and also continuously adjacent blade shaft 74.

In the case of cylinder 46 and each blade 76, outer edge 86 of blade 76 is always continuously adjacent inner surface 47 of cylinder 46 when edge 86 is not in communication with either hole 58 or 60. This is due to the fact that any cross-section of cylinder 46 normal to longitudinal axis 80 defines a circle or a pair of concentric arcs. Thus, all points along inner surface 47 are equidistant from axis 80 and corresponding points on outer edge 86 of blade 76 rotate along a circular path closely adjacent to inner surface 47. However, an airlock similar to airlock 10 may function properly even where the cross-section as discussed above in not circular. Thus, it is not required that outer edge 86 of blade 76 or a perimeter of a blade always be continuously adjacent the inner surface of the blade housing. Rather, where, as in the preferred embodiment, outer edge 86 is coplanar with longitudinal axis 80, airlock 10 will operate properly as long as at all times, the outer edge 86 of at least one blade 76 is continuously adjacent inner surface 47 when disposed between leading edge 55 of entrance hole 58 and trailing edge 61 of exit hole 60 and simultaneously the outer edge 86 of at least one other blade 76 is continuously adjacent inner surface 47 when disposed between trailing edge 57 of entrance hole 58 and leading edge 59 of exit hole 60. Most importantly and more broadly stated, blade assembly 72 defines at least one airlock chamber 77 so that at no time is there fluid communication between entrance hole 58 and exit hole 60, as explained in more detail further below.

In operation, dust collection system 12 works generally as follows. Machines 14 create various sizes of particulate material, such as dust, small wood chips, metal shavings and so forth. In reference to system 12, these materials can be broadly broken into light materials and heavy materials 26. Blower 18 creates a pressure differential between machines 14 and blower 18 amounting to a suction from machines 14 towards blower 18 so that the heavy and light materials are entrained in air and moved through pipe 16 into blower 18 and then are blown out of blower 18 through pipe 20. The materials exit pipe 20 into separator 22, which has a larger diameter than pipe 20, thus reducing the velocity of the air moving through the system. The light particles remain entrained in the upward airflow that moves through filter 24 while the heavy material 26 falls downwardly from separator 22 into airlock 10. Ultimately, heavy material 26 is discharged from airlock 10 into collection bin 28 or onto another collection site. The light material is captured by filter 24.

In accordance with the present invention, airlock 10 functions as follows. Motor 30 is activated to provide a source of power to rotate drive shaft 82 via gear box 32, which is used to control the rotational velocity of drive shaft 82 and in turn blade shaft 74 and blades 76. Generally, the rotational velocity of blade shaft 74 and blades 76 is relatively slow and is intended to allow heavy material 76 to be discharged from airlock 10 by gravitational force alone. Thus, the rotational velocity is generally not intended to significantly effect the velocity with which heavy material 26 is discharged from airlock 10, although it may impart such an effect. Typically, blades 76 rotate at a constant velocity regardless of how full airlock 10 is. Outer perimeters 79 of respective end plates 78 and outer edges 86 of respective blade 76 lie closely adjacent or are in contact with inner surface 47 of cylinder 46, and may create an airtight seal between these respective surfaces where desired or needed. This is also true of the close proximity between each end plate 78 and each of blade 76 and blade shaft 74.

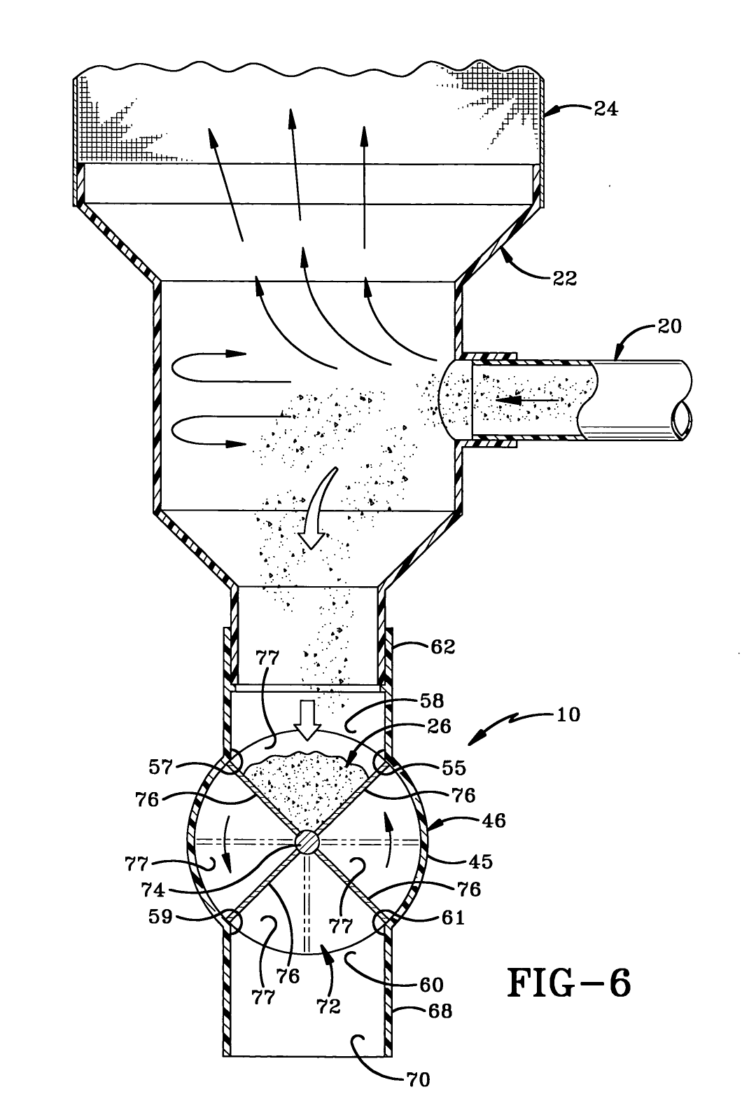

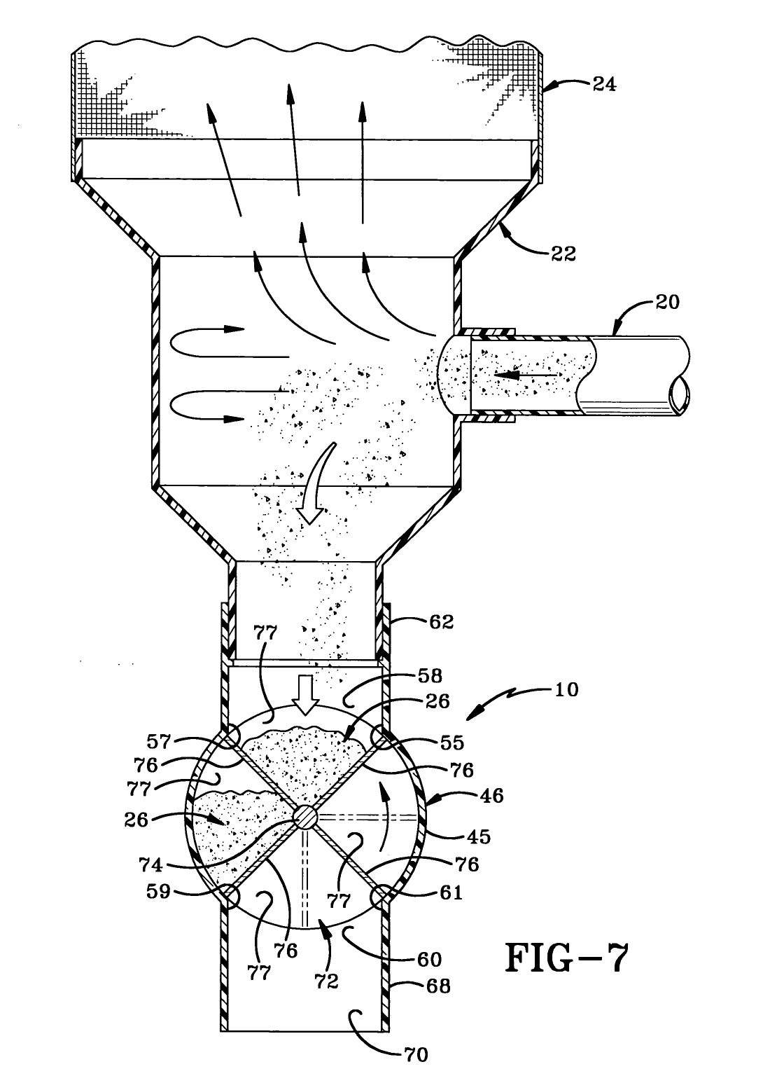

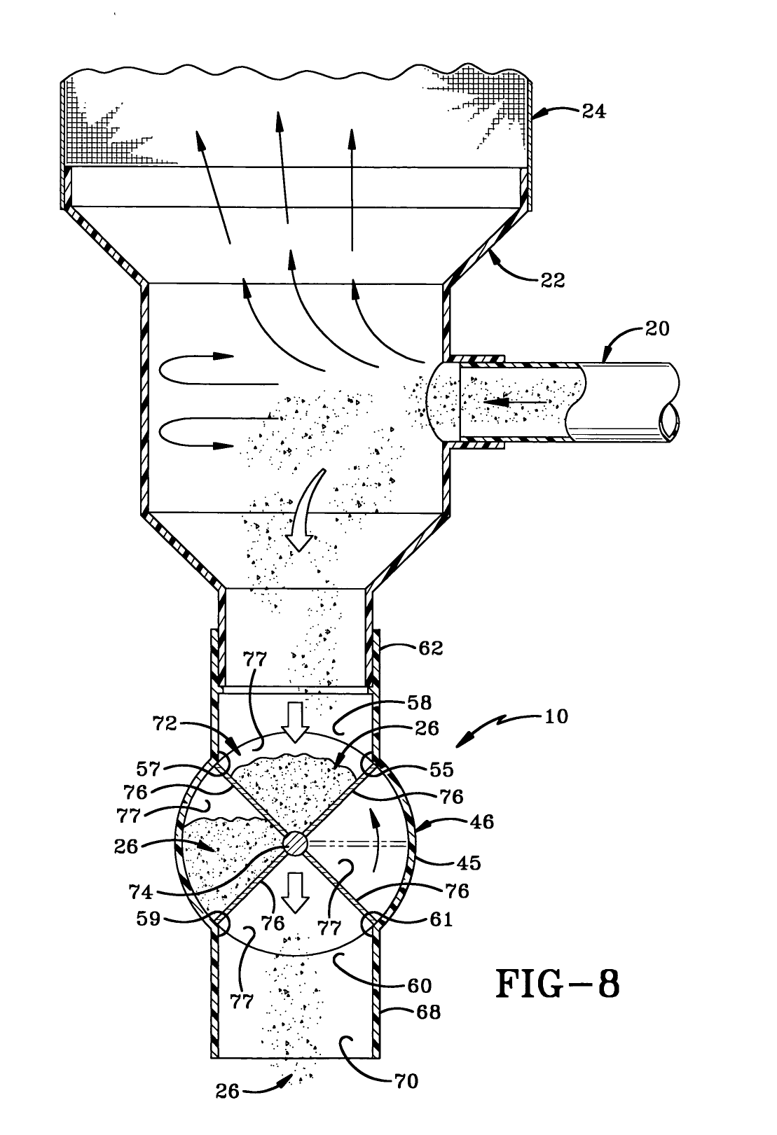

FIGS. 6-8 further show the function of airlock 10. FIG. 6 shows the flow of air through the system and the movement of the light material and heavy material 26 as the air and particulate materials exit pipe 20 and enter separator 22, which separates the light and heavy materials in a manner commonly known in the art. The solid black arrows shown within pipe 20 and separator 22 and pointing upward towards filter 24 indicate air flow and may further represent the light material for the purposes herein. The broad arrows pointing downwardly indicate the direction of flow of heavy material 26 into airlock 10. The light material follows the upward airflow and is captured by filter 24. Heavy material 26 falls downwardly into airlock 10 so that it lies in an airlock chamber 77. The arrows in airlock 10 of FIG. 6 indicate the direction of rotation of blade shaft 74 and blade 76 about longitudinal axis 80. In FIG. 6, an initial accumulation of heavy material 26 is seen in an upward orientation. As shown in FIG. 7, initial accumulation of heavy material 26 has moved to a lateral position while a second subsequent accumulation of heavy material 26 is in another airlock chamber 77 in the upper position as blades 76 have rotated approximately 90 degrees counterclockwise from their position in FIG. 6. FIG. 8 shows blades 76 further rotated another 90 degrees so that the initial accumulation of heavy material 26 is discharged by gravity downwardly through exit duct 68 while the second accumulation is in the lateral position and a third subsequent accumulation is in yet another airlock chamber 77 in the upper position.

In accordance with the present invention, the rotor body or blade assembly 72 defining airlock chambers 77 is configured to prevent fluid communication between entrance hole 58 and exit hole 60 at all times, as further described below. Airlock 10 does not require a seal between the rotor body or blade assembly 72 and inner surface 47 of housing or cylinder 46, although a seal is preferable where it is desirable or necessary to prevent any bleed through of air or small particulate material through airlock 10. Generally, it is sufficient that blade assembly 72 and inner surface 47 are closely adjacent one another so as to create a minimal-leakage arrangement. Thus, when blade assembly 72 defining airlock chambers 77 is configured to prevent fluid communication between entrance hole 58 and exit hole 60 at all times, it means either that a seal is formed between blade assembly 72 and the inner surface of the blade housing or that the amount of leakage between blade assembly 72 and the inner surface of the housing is minimal and insignificant in terms of the purpose for which the airlock is to be used. Obviously, in certain environments, a certain increase in the degree of such leakage may be acceptable. However, it is clearly beneficial in general to minimize such leakage to the greatest degree possible within reasonable limits and cost factors.

Because airlock 10 either creates an airtight seal or allows minimal leakage at all times while blades 76 are rotating about axis 80, there is no need to form a further seal between dust collection system 12 and a collection bin 28. Thus, if collection bin 28 is used, there is no need to disconnect, re-connect or ensure a seal between collection bin 28 and system 12. Further, there is no need to turn blower 18 off in order to remove and empty collection bin 28. Another collection bin may be easily inserted with little or no spillage of heavy material 26 while bin 28 is being emptied. Alternatively, by way of example, heavy material 26 may be discharged into a collection bin having wheels or onto a pallet or conveyor for added convenience in removing accumulations material 26.

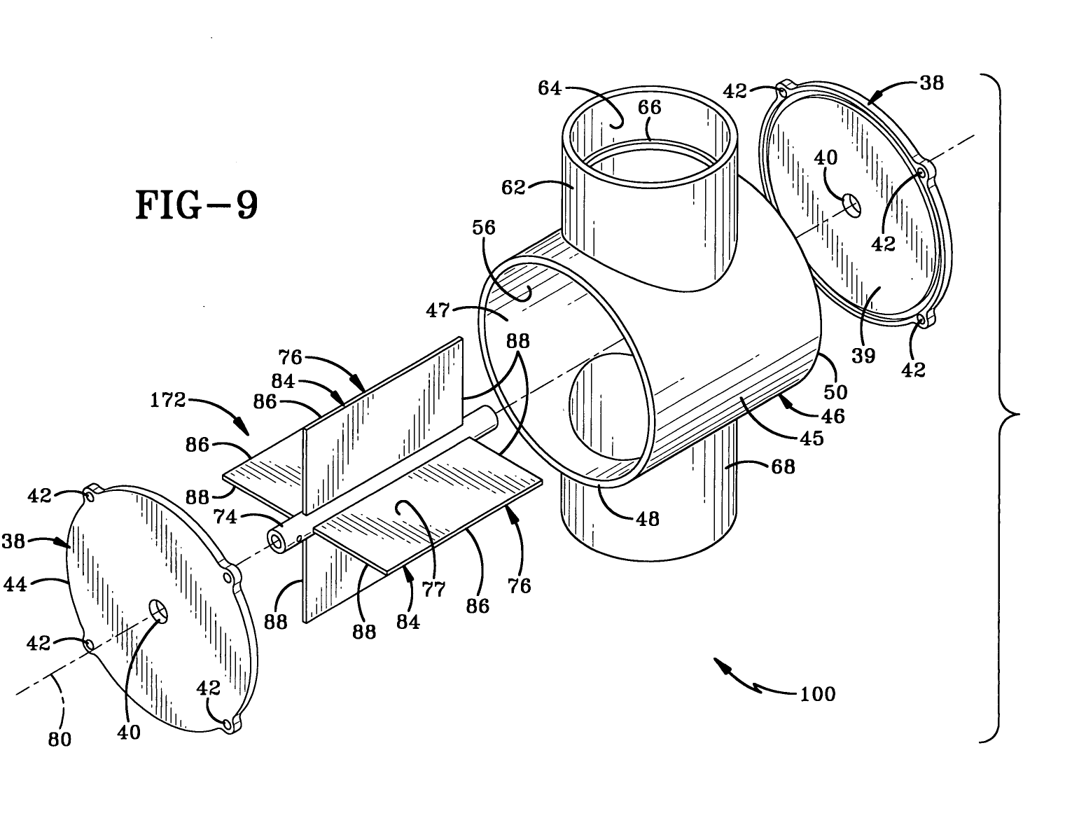

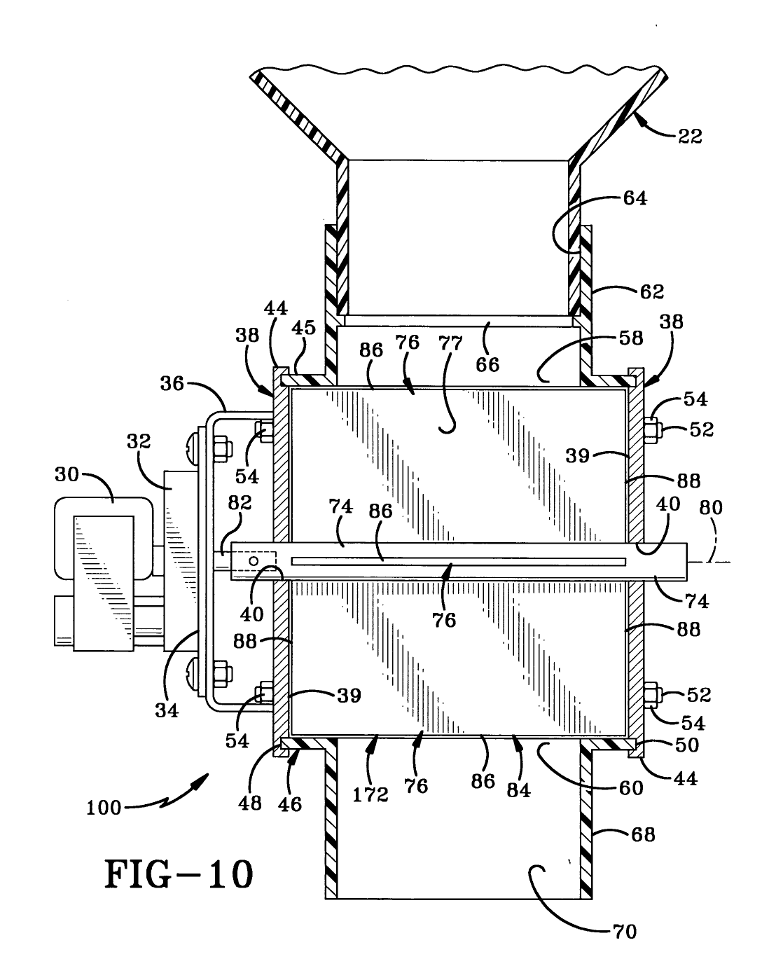

A second embodiment of the airlock of the present invention is indicated generally at 100 and is shown in FIGS. 9-10. Airlock 100 is similar to airlock 10 except that a slightly different blade assembly 172 includes no end plates 78. Otherwise, all the numbering in relation to airlock 100 is the same as in regard to airlock 10. Due to the lack of end plates 78, ends 88 of blades 76 lie adjacent respective inner surfaces 39 of caps 38. Once again, the term adjacent means lying closely adjacent or in contact with, and thus in the second embodiment, an airtight seal or minimal-leakage arrangement is maintained as described above, while also including a seal or minimal-leakage arrangement between ends 88 and respective surfaces 39. In the second embodiment, the airtight seal or minimal-leakage arrangement may be described as being between the inner surface of the blade housing and outer perimeter 84 of each blade 76. Blade assembly 172 defines an airlock chamber 77 between each adjacent pair of blades 76 and between wedge-shaped portions of respective caps 38.

In operation, airlock 100, except in regard to the differences noted between airlock 10 and airlock 100, functions in the same manner as airlock 10.

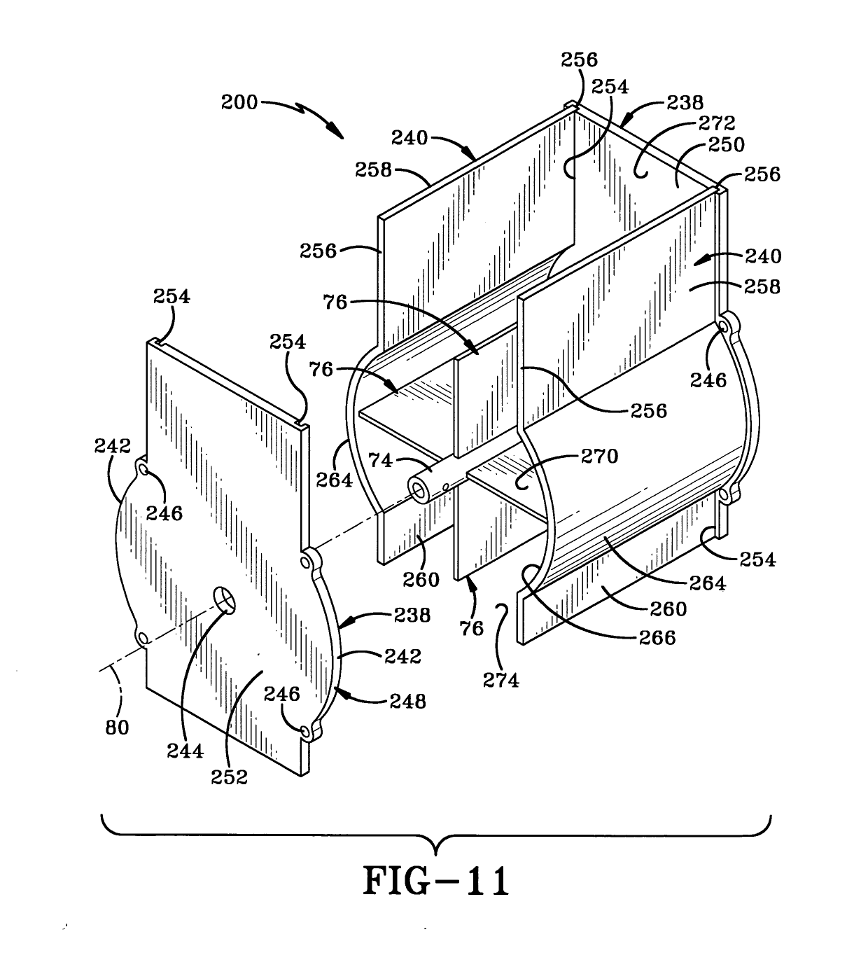

A third embodiment of the airlock of the present invention is indicated generally at 200 and is shown in FIGS. 11 -12. Airlock 200 is similar to airlock 100 except that the blade housing and entry and exit ducts are formed differently and the ducts have a rectangular cross-section. Blade shaft 74 and blades 76 are the same as in airlock 100. The blade housing and entry duct 262 and exit duct 268 are all formed by a pair of opposed end walls 238 and a pair of opposed sidewalls 240. Each end wall 238 is generally rectangular and has a pair of opposed arcuate sections 242 extending outwardly from the long sides of the rectangle. Each end wall 238 defines a generally central hole 244 and a plurality of mounting holes 246 adjacent an outer perimeter 248 of end wall 238. Each end wall 238 further includes an inner surface 250 and an outer surface 252 and defines a pair of grooves or slots 254 extending inwardly from inner surface 250 adjacent outer perimeter 248. Sidewalls 240 have a pair of opposed ends 256 which fit into respective slots 254 of respective end walls 238 to form a tongue in groove fit. Sidewalls 240 further include a rectangular upper portion 258, a rectangular lower portion 260 and a middle portion 264 disposed between and connected to upper portion 258 and lower portion 260. Middle portion 264 is substantially an arc of a cylinder and has an inner surface 266. In conjunction with portions of respective end walls 238, the pair of opposed middle portions 264 define an interior chamber 270 therebetween. In combination with portions of respective end walls 238, upper portions 258 of sidewalls 240 form entry duct 262 defining entrance opening 272. In combination with portions of respective end walls 238, lower portions 260 of sidewalls 240 form an exit duct 268 defining an exit opening 274.

In operation, airlock 200 is substantially similar to airlock 100. The distinction is only related to the specifics of where the air tight seals or minimal-leakage arrangements are formed, which are nonetheless analogous to those of airlock 100. Specifically, outer edge 86 of blades 76 lie adjacent inner surface 266 of middle section 264 to form one area of the seal or minimal-leakage arrangement. The other portion of the seal or minimal-leakage arrangement is formed between each end 88 of blade 76 and inner surface 250 of respective end walls 238. Otherwise, as with airlock 100, motor 30 is connected to gear box 32 and mounted on mounting member 34, which is in turn mounted on mounting plate 36. In the case of airlock 200, mounting plate 36 is mounted on one end wall 238, but the function otherwise is the same. Airlock 200 allows for an easier connection with dust collection system ducts having a rectangular shape.

It will be understood that a variety of changes could be made to structures described herein without departing from the spirit of the invention. For example, blade assembly 72 is but one type of rotor body which may rotate about longitudinal axis 80 so that airlock of the present invention may operate properly. Most importantly, the rotor body defines at least one airlock chamber so that at no time is there fluid communication between the entrance hole and the exit hole. Thus, for instance, the rotor body may be a solid body with an airlock chamber formed therein, like a solid cylinder with a wedge cut out of it. Alternately, the rotor body may be hollow. Rotor bodies may have a wide variety of shapes, as noted more particularly below with regard to a rotor body comprising a blade assembly and blades.

An airlock may have only one airlock chamber, for example, a solid or hollow cylinder with one airlock chamber formed therein. In this case, the airlock chamber would receive heavy materials 26 from the rest of the dust collection system and then be rotated to discharge heavy material 26. As the airlock chamber rotated to positions not in communication with the entrance hole, then heavy material 26 would accumulate on the outer perimeter of the cylinder until the airlock chamber was once again in communication with the entrance hole to receive the accumulated heavy material 26. While such an embodiment is not preferred, it is clearly operational.

Blades 76 may have a variety of shapes other than rectangular and still perform in accordance with the concept of the invention. One example would be blades that have substantially semi-circular outer perimeter which would form the seal between the blade and inner surface of the blade housing. In such a case, the blade housing would be substantially spherical. Trapezoidal or other shapes may also be used. The rectangular or square shape is simple and allows for the insertion of the blade assembly easily into the blade housing from one side, but other configurations may perform with equal success. In addition, the blades may be angled, including angles that are variable. Innumerable configurations for the blades are imaginable, although blades similar to blades 76 maintain a very simple, effective and cost-efficient configuration.

By way of further example, motor 30 need not be electrical, and any power source capable of rotating blades 76 will allow airlock 10 to function. Further, gear box 32 may be eliminated where the power source allows blades 76 to rotate at an appropriate speed.

While entrance hole 58 and exit hole 60 are preferably in opposed relation, they need not be, as long as heavy material 26 may enter and exit airlock 10, 100 or 200 through these respective holes. Further, entry duct 62 need not extend vertically upwardly as long as heavy material 26 may enter through duct 62. Likewise, exit duct 68 need not extend vertically downward as long as material 26 may exit properly. Thus, for example, these ducts may be sloped.

Airlocks 10, 100 and 200 are all situated with blades 76 rotating about a substantially horizontal longitudinal axis 80. Thus, entrance hole 58 and exit hole 60 are formed in sidewall 45 of airlock 10 and 100 and in an analogous position in airlock 200. In these configurations, outer edges 86 of blades 76 intermittently communicate with holes 58 and 60 as blades 76 rotate. However, a similar airlock may be situated with a longitudinal axis being substantially vertical. In this configuration, entrance and exit holes may be formed in respective end walls so that ends 88 of blades 76 intermittently communicate with the holes as blades 76 rotate. Entry and exit ducts would then connect the end walls and communicate with respective entrance and exit holes.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An airlock for discharging particulate material comprising:
a housing defining an interior chamber adapted for retaining particulate material, an entrance hole adapted for receiving particulate material, and an exit hole adapted for discharging particular material, each hole being in fluid communication with the interior chamber;
a rotor body disposed within the interior chamber and being rotatable about a longitudinal axis; and
the rotor body and housing defining at least one airlock chamber so that at no time is there fluid communication between the entrance hole and the exit hole.

2. The airlock of claim 1 further including a power source to rotate the rotor body.

3. The airlock of claim 2 wherein an entry duct extends outwardly from the housing and defines an entrance opening in fluid communication with the entrance hole.

4. The airlock of claim 3 wherein an exit duct extends outwardly from the housing and defines an exit opening in fluid communication with the exit hole.

5. The airlock of claim 4 wherein the entrance hole and exit hole are situated generally opposite one another.

6. The airlock of claim 1 wherein the entrance hole and exit hole are situated generally opposite one another.

7. The airlock of claim 6 wherein an entry duct extends outwardly from the housing and defines an entrance opening in fluid communication with the entrance hole.

8. The airlock of claim 1 wherein the rotor body forms an airtight seal with the housing at all times to prevent fluid communication between the entrance and exit holes.

9. The airlock of claim 1 wherein the rotor body is a blade assembly including at least three blades extending radially outwardly from the axis.

10. The airlock of claim 9 wherein the blade assembly and housing define an airlock chamber between each adjacent pair of blades.

11. The airlock of claim 9 wherein the blade assembly includes a pair of opposed end plates disposed within the interior chamber and extending radially outwardly from the longitudinal axis and being rotatable about the axis; each airlock chamber being disposed between a portion of each end plate.

12. The airlock of claim 9 wherein the blades are connected to a blade shaft.

13. The airlock of claim 9 wherein at any given time, at least two blades form an airtight seal with the blade housing to ensure that at no time is there direct fluid communication between the entrance hole and the exit hole.

14. The airlock of claim 13 wherein the blades rotate at a constant velocity regardless of how full the airlock is.

15. A particulate collection system comprising:
a blower adapted to fluidly communication with a source of fine and heavy particulate material;
a separator adapted for separating the fine and heavy particulate material;
a bin for receiving the heavy material;
an airlock positioned between the separator and the bin to prevent direct fluid communication between the separator and the bin; and
an inlet and an outlet formed in the airlock.

16. The particulate collection system of claim 15 further comprising at least one particulate receiving trough within the airlock.

17. The particulate collection system of claim 16 in which at least one particulate receiving trough is rotatably mounted on a shaft within the airlock to rotate between a first position wherein the trough is in communication with the inlet, and a second position wherein the trough is in communication with the outlet.

18. The particulate collection system of claim 17 in which there are at least three troughs mounted on the shaft.

19. The particulate collection system of claim 17 further comprising a motor mounted to the shaft for rotating the shaft and the troughs within the airlock.

20. The particulate collection system of claim 17 in which a duct extends between the separator and the airlock, and in which the duct is adapted to receive the heavy particulate from the separator and put it into a trough within the airlock whereby rotation of the airlock is adapted to empty the heavy particulate material in the trough through the outlet and into the bin.

21. The particulate collection system of claim 20 in which the airlock includes a housing and in which the duct extends outwardly from the housing where it is in fluid communication with the inlet.

22. The particulate collection system of claim 21 in which the inlet and outlet are generally opposed to one another.

23. The particulate collection system of claim 15 in which the rotatably troughs are formed by a plurality of blades, and in which each rotatably trough forms an airtight seal with the housing at all times to prevent fluid communication between the inlet and outlet.

24. The particulate collection system of claim 23 in which there are three blades extending outwardly from the shaft.
